(19) United States
(12) Patent Application Publication
(10) Pub. No.: US 2026/0090521 A1
(43) Pub. Date: Apr. 2, 2026

(54) A SYSTEM AND METHOD FOR ESTIMATING BODY CONDITION SCORE OF AN ANIMAL

(71) Applicant: TECHNOLOGICAL UNIVERSITY DUBLIN, Dublin (IE)

(72) Inventors: Robert ROSS, Dublin (IE); Bianca SCHOEN PHELAN, Dublin (IE); Tamil Selvi Bancras SAMUEL, Dublin (IE); Vinayaka Reddy HANUMATHAPPA, Dublin (IE); Fan ZHANG, Dublin (IE)

(21) Appl. No.: 19/113,375

(22) PCT Filed: Sep. 19, 2023
(86) PCT No.: PCT/EP2023/075858

§ 371 Date: Mar. 19, 2025

(30) Foreign Application Priority Data
Sep. 19, 2022 (GB) 2213698.0

(51) Int. Cl. A01K 29/00; G06T 7/00

(52) U.S. Cl. CPC A01K 29/002; G06T 7/0012; A01K 2227/101; G06T 2207/10048; G06T 2207/20084; G06T 2207/20212

(57) ABSTRACT

A system and method for calculating an estimate of a body condition score (BCS) for a bovine animal is described. The system comprises a visual spectrum camera configured to collect visual spectrum data of the animal in an area of interest, an infra-red camera configured to collect near infra-red spectrum data of the animal related to soft tissue distribution around the area of interest, and one or more neural networks trained using a first training dataset comprising combined imaging data for each of a plurality of animals and corresponding BCS's for the plurality of animals, in which the combined imaging data for each animal comprises the visual spectrum data and the near infra-red spectrum data for the animal. The system also includes a processor configured to: receive the combined imaging data for the animal and apply the one or more neural networks to the combined imaging data for the animal to calculate an estimate of a BCS for the animal.

### TECHNICAL FIELD

The present disclosure relates to a system and method to calculate a body condition score for an animal, and more specifically to detect a dairy cow and calculate its body condition score.

### BACKGROUND

In dairy farming, Body Condition Scoring (BCS) is a measure of the fat distribution around a cow's pin bones, and this score can indicate whether an animal is in prime condition or not for insemination and subsequent contribution to the farm's milk output. BCS influences the farmer's decision on when to use Artificial Insemination (AI), what feed to provide, and directly impacts on milk yield and farmer's profit. For example, a cowwill be dismissed after three unsuccessful insemination attempts.

The impact of accurate BCS scoring are widespread. Accurate BCS estimation contributes to the welfare of the animal as the technology identifies when the animal is under or over-weight and can hence have its diet adjusted as needed.

Related to this, at an environmental and sustainability level, timely insemination and diet management can reduce the overall methane emissions from a given cow, as diet can be adjusted, medications administered, or even indicate when an appropriate time for slaughter has been reached.

The problem in the current state of the art is to correctly determine a cow's BCS using a computer implemented system and method in noisy real-world environments where animals may be in motion, soiled, or in imperfect lighting models.

Currently, BCS estimation is done manually by an experienced stockman. This requires resources and is prone to human error. Systems for the automatic assessment of BCS scores have been proposed in the literature, but to this point these tend to focus on: (a) explicit pin bone identification; (b) stereoscopic imaging; and (c) cows that are typically stationary and well behaved. The realities of BCS assessment means that these assumptions are often invalid and lead to errors in the assessment process. It is for this reason that automated BCS assessment systems are not widespread. Other systems rely on visual whole body recognition systems. Several key points of a cow's body are captured in 2-dimensional (2D) cameras. These points are used for identification as well as health score assignment. This is not specifically targeted at BCS, but provides an overall statement of health, which includes BCS. The scoring system requires the training of a farmer or stockperson to draw appropriate conclusions. Additionally, cows rarely walk in perfect line formation, therefore obstructions among cows are likely and might impact on the accuracy of identification and the respective generation of a health score. In addition to this, the sheds are very dust prone environments, which is likely to cause noise during the data collection process.

Oh et al. (Biomed Opt Express. 2020 Jun. 1; 11(6): 2951-2963) describe the use of Infrared+RGB wavebands for soft tissue analysis.

Fuentes et al. (Sensors (Basel). 2021 October; 21(20): 6844. Biometric Physiological Responses from Dairy Cows Measured by Visible Remote Sensing Are Good Predictors of Milk Productivity and Quality through Artificial Intelligence) describe collecting both visual and thermal infrared imaging for a range of biomarkers. Thermal IR only sees the heat signature of a surface (temperature). It is very low resolution (both in terms of spatial resolution and temporal resolution (read frame rate)). In addition, thermal infrared lacks the ability of near infrared to see through surfaces—or at least to see properties of the surface that RGB does not pick up.

CN 114997725 discloses an automated body condition scoring system for dairy cows. Visible camera data is used in conjunction with a trained convolutional neural network to estimate a BCS score for the captured subject.

CN 217285749 discloses an image recognition-based device for estimating BCS for dairy cows. This document discloses using an IR unit to capture image data of the cow and using a programmed image recognition software to determine the BCS automatically from the images.

US 2019/0105006 discloses a method of combining infrared and visible images with automatic image recognition algorithms to determine the parameters of animals.

However, the accuracy of the BCS estimation may be influenced by the viewpoint and position of the camera relative to the cow. It may not capture all aspects of body condition equally well. Further, the models trained in one environment may not perform as well in different settings or with cows from diverse geographic regions. Adaptation and fine-tuning may be necessary. Also, changes in lighting conditions, weather, or the presence of obstructions in the cow's environment could affect the accuracy of image-based BCS assessment.

It is an object of the invention to overcome at least one of the above-referenced problems.

### SUMMARY

In a first aspect, there is provided a computer implemented method for calculating a biometric parameter estimate for an animal, as set out in the appended claims, the method comprising the steps of:
collecting visual spectrum data of the animal in an area of interest using a visual spectrum camera;
collecting near infra-red spectrum data of the animal related to soft tissue distribution around the area of interest using an infra-red camera;
analysing the visual spectrum data and the near infra-red spectrum data by combining the visual spectrum data and the near infra-red spectrum data to provide combined imaging data for the animal; and
applying one or more first neural networks to the combined imaging data for the animal to calculate a biometric parameter sample estimate for the animal, in which the one or more first neural networks are created by (a) obtaining a first training dataset comprising combined imaging data for each of a plurality of animals and corresponding biometric parameters for the plurality of animals and (b) training one or more neural networks using the training dataset.

In any embodiment, the biometric parameter is an estimate of a body condition score (BCS) for an animal. Other biometric parameters applicable to the method and system described herein are animal heat, respiration, and milk production yield.

In any embodiment, the method comprises applying a confidence estimate model to the calculated biometric parameter sample estimate for the animal so as to calculate the accuracy of the calculated biometric parameter sample estimate for the animal, in which the confidence estimate model is created by (a) obtaining a confidence training dataset comprising combined imaging data for each of a plurality of animals in a good imaging position and combined imaging data for each of a plurality of animals in a bad imaging position, and (b) generating the confidence estimate model using the confidence training dataset.

In any embodiment, the confidence estimate model comprises one or more neural networks. In any embodiment, the neural network comprises a machine learning algorithm.

In any embodiment, the method comprises a step of longitudinal analysis over a time period to estimate most likely biometric parameter estimates over a specified sampling period. Longitudinal analysis combines multiple features, including biometric parameter estimates and biometric parameter confidence measures, to estimate an aggregate high-quality biometric parameter estimate over any given sampling time, for example 1, 2, 3, 4, 5, 6, 7 or 8 weeks. The method makes use of weighting function and a rolling window of measurements of each animal where due to data loss or occlusion the observation for an animal on a given day may or may not be made available. The parameterization of such a weighting function maybe hand-set or derived via an automated learning technique.

In any embodiment, the animal is bovine.

In any embodiment, the data collected by the visible spectrum camera system is a video recording.

In any embodiment, the area of interest is the rear of the animal surrounding the animal's pin bones.

In any embodiment, the visible spectrum camera system comprises a single RGB camera configured to capture images of the area of interest.

In any embodiment, the visible spectrum image data comprises the collected visual spectrum data.

In any embodiment, near infra-red spectrum data collected by the infra-red camera is a video recording.

In any embodiment, the infra-red camera and the visual spectrum camera are contained in a single unit.

In any embodiment, a pair of such single units are positioned in separate locations in a fixed position above the area of interest.

In any embodiment, the first unit is positioned at a fixed angle with respect to the second.

In any embodiment, the fixed angle between the camera units is from 20 to 70 degrees.

In any embodiment, the fixed angle between the camera units is from 35 to 60 degrees.

In any embodiment, the fixed angle between the camera units is around 45 degrees.

In any embodiment, the infra-red camera and the visual spectrum camera in a camera unit are separated by less than 10 cm.

In any embodiment, the infra-red camera and the visual spectrum camera in a camera unit are separated by 5-6 cm.

In any embodiment, the first neural network comprises a machine learning method.

In any embodiment, the machine learning method comprises a deep learning algorithm.

In any embodiment, the combined imaging data is fed to the neural network prior to the corresponding BCS scores.

In any embodiment, the visual spectrum data and the near infra-red data are combined implicitly by a script.

In any embodiment, the first training dataset comprises combined imaging data for each of a plurality of animals and corresponding biometric parameters for the plurality of animals, in which the plurality of animals comprises at least 50, 100,150, 200, 300, 400 or 500 animals. any embodiment, the BCS score ranges from 1 to 5.

In any embodiment, new data of the same type will be automatically classified in this target range by the neural network.

In any embodiment, the system works in real time or near real time to provide estimates of BCS score and BCS confidence.

In any embodiment, the lag with respect to real time is around 2-3 seconds.

In any embodiment, the BCS estimate and the BCS confidence are captured twice per day for a given animal.

In any embodiment, a master algorithm assesses the BCS confidence and BCS score for a given animal over a specified rolling window.

In any embodiment, a master algorithm estimates the most likely BCS score for a given animal by accounting for values and confidence levels for an animal over the specified rolling window.

In any embodiment, the rolling window length is 7 days.

In any embodiment, the animal has an RFID tag which is scanned to identify the animal which is having its BCS measured.

In any embodiment, the automated estimates and the most likely BCS score are communicated to a cloud platform for long term storage and review.

In any embodiment, the step of training the one or more neural networks comprises the steps:
using a first portion of the first training dataset to adjust weights of the neural networks so as to produce one or more trained neural network; and
Inputting a second portion of the first training dataset to the one or more trained neural network to validate the performance of the trained neural network in reproducing the corresponding known biometric parameters so as to identify a validated neural network,
and wherein the step of applying the one or more neural networks to the combined imaging data for an animal comprises applying the validated neural network to the combined imaging data for an animal so as to calculate a biometric parameter for the animal.

In a second aspect, the invention provides a computer program product comprising a computer usable medium, where the computer usable medium comprises a computer program code that, when executed by a computer apparatus, calculates a biometric parameter for an animal, or calculates the accuracy of the calculated biometric parameter for the animal.

In any embodiment, the biometric parameter is an estimate of a body condition score (BCS) for an animal. Other biometric parameters applicable to the method and system described herein are animal heat, animal respiration, and animal milk production yield.

In a third aspect, there is provided a system for calculating a biometric parameter estimate for an animal, the system comprising:
a visual spectrum camera configured to collect visual spectrum data of the animal in an area of interest;
an infra-red camera configured to collect near infra-red spectrum data of the animal related to soft tissue distribution around the area of interest;
one or more neural networks trained using a first training dataset comprising combined imaging data for each of a plurality of animals and corresponding biometric
parameters for the plurality of animals, in which the combined imaging data for each animal comprises the visual spectrum data and the near infra-red spectrum data for the animal; and
a processor configured to:
receive the combined imaging data for the animal; and apply the one or more neural networks to the combined imaging data for the animal to calculate a biometric parameter estimate for the animal.

In any embodiment, the biometric parameter is an estimate of a body condition score (BCS) for an animal. Other biometric parameters applicable to the method and system described herein are animal heat, animal respiration, and animal milk production yield.

In any embodiment, the system comprises a confidence estimate model to calculate the accuracy of the calculated biometric parameter sample estimate for the animal, in which the confidence estimate model is trained using a confidence training dataset comprising combined imaging data for each of a plurality of animals in a good imaging position and combined imaging data for each of a plurality of animals in a bad imaging position, in which the processor is configured to apply the confidence estimate model to the combined imaging data for the animal to calculate the accuracy of the calculated biometric parameter sample estimate for the animal.

In any embodiment, the confidence estimate model comprises one or more neural networks.

In any embodiment, the neural network comprises a machine learning algorithm.

In any embodiment, the system comprises a sensor for detecting an Identification tag attached to an animal.

In any embodiment, in which the tag is an RFID tag, the sensor is an RFID sensor. Other tags and sensors may be employed such as barcodes and barcode readers.

In any embodiment, the system is configured to perform longitudinal analysis for one or more animals over a time period to estimate most likely biometric parameter estimates for the or each animal over a specified sampling period. Longitudinal analysis combines multiple features, including biometric parameter estimates and biometric parameter confidence measures, to estimate an aggregate high-quality biometric parameter estimate over any given sampling time, for example 1, 2, 3, 4, 5, 6, 7 or 8 weeks. The method makes use of weighting function and a rolling window of measurements of each animal where due to data loss or occlusion the observation for an animal on a given day may or may not be made available. The parameterisation of such a weighting function may be handset or derived via an automated learning technique.

In any embodiment, the animal is bovine.

In any embodiment, the data collected by the visible spectrum camera system is a video recording.

In any embodiment, the area of interest is the rear of the animal surrounding the animal's pin bones.

In any embodiment, the visible spectrum camera system comprises a single RGB camera configured to capture images of the area of interest.

In at least one embodiment of the present invention, the visible spectrum image data comprises the collected visual spectrum data.

In any embodiment, the data collected by the infra-red camera is a video recording.

In any embodiment, the infra-red camera and the visual spectrum camera are contained in a single unit.

In any embodiment, a pair of such units are positioned in separate locations in a fixed position above area of interest. In any embodiment, the first unit is positioned at a fixed angle with respect to the second.

In any embodiment, the angle between the camera units is between 20 and 70 degrees.

In any embodiment, the angle between the camera units is around 45 degrees.

In any embodiment, the infra-red camera and the visual spectrum camera in a camera unit are separated by less than 10 cm.

In any embodiment, the infra-red camera and the visual spectrum camera in a camera unit are separated by 5-6 cm.

In any embodiment, the at least one neural network comprises a machine learning method.

In any embodiment, the machine learning method comprises a deep learning algorithm.

In any embodiment, the combined imaging data is fed to the neural network to estimate labels for BCS values and BCS confidence.

In any embodiment, the visual spectrum data and the infra-red data are combined to form the combined imaging data implicitly by a script.

In any embodiment, the neural network is trained by providing a large number of inputs (e.g. greater than 50, 100, 150, 200, 300, 400 or 500) which comprise combined imaging data and an associated label (corresponding BCS's in the case of the first neural network)

In any embodiment, the label comprises a BCS score.

In any embodiment, the BCS score ranges from 1 to 5.

In any embodiment, the data model has been trained on this data, new data of the same type will be automatically classified in this target range by the neural network.

In any embodiment, the system works in real time or near real time to provide estimates of BCS scores and optional BCS confidence estimates.

In any embodiment, the lag with respect to real time is around 2-3 seconds. In any embodiment, the BCS estimate and the BCS confidence are captured twice per day for a given animal.

In any embodiment, a master algorithm assesses the BCS confidence and BCS score for a given animal over a specified rolling window.

In any embodiment, a master algorithm estimates the most likely BCS score for a given animal by accounting for values and confidence levels for an animal over the specified rolling window.

In any embodiment, the rolling window length is 7 days.

In any embodiment, the animal has an RFID tag which is scanned to identify the animal which is having its BCS measured.

In any embodiment, the automated estimates and the most likely BCS score are communicated to a cloud platform for long term storage and review.

Other aspects and preferred embodiments of the invention are defined and described in the other claims set out below.

### BRIEF DESCRIPTION OF THE FIGURES

FIG. 1 is an illustration of the architecture of the system of the invention;

FIG. 2 is an illustration of the hardware employed in the system and method of the invention;

FIG. 3 is a schematic illustration of the position of the cameras inside the red box and outside view of the red box. A transparent cover is fixed on the outer casing of the red box to provide protection for the camera lenses; and

FIG. 4 is a flowchart illustrating a method for calculating a biometric parameter estimate for an animal.

### DETAILED DESCRIPTION OF THE INVENTION

All publications, patents, patent applications and other references mentioned herein are hereby incorporated by reference in their entireties for all purposes as if each individual publication, patent or patent application were specifically and individually indicated to be incorporated by reference and the content thereof recited in full.

### Definitions and General Preferences

Where used herein and unless specifically indicated otherwise, the following terms are intended to have the following meanings in addition to any broader (or narrower) meanings the terms might enjoy in the art:

Unless otherwise required by context, the use herein of the singular is to be read to include the plural and vice versa. The term “a” or “an” used in relation to an entity is to be read to refer to one or more of that entity. As such, the terms “a” (or “an”), “one or more,” and “at least one” are used interchangeably herein.

As used herein, the term “comprise,” or variations thereof such as “comprises” or “comprising,” are to be read to indicate the inclusion of any recited integer (e.g. a feature, element, characteristic, property, method/process step or limitation) or group of integers (e.g. features, element, characteristics, properties, method/process steps or limitations) but not the exclusion of any other integer or group of integers. Thus, as used herein the term “comprising” is inclusive or open-ended and does not exclude additional, unrecited integers or method/process steps. As used herein, the term “Body Condition Scoring” or “BCS” refers to a measure employed in dairy farming of the fat distribution around a cow's pin bones, and this score can indicate whether an animal is in prime condition or not for insemination and subsequent contribution to the farm's milk output. BCS influences the farmer's decision on when to use AI, what feed to provide, and directly impacts on milk yield and farmer's profit. For example, a cow will be dismissed after three unsuccessful insemination attempts.

As used herein, the term “near infra-red” refers to the near-infrared region of the electromagnetic spectrum generally understood to be from 780 nm to 2500 nm.

### Exemplification

The invention will now be described with reference to specific Examples. These are merely exemplary and for illustrative purposes only: they are not intended to be limiting in any way to the scope of the monopoly claimed or to the invention described. These examples constitute the best mode currently contemplated for practicing the invention.

### System Installation

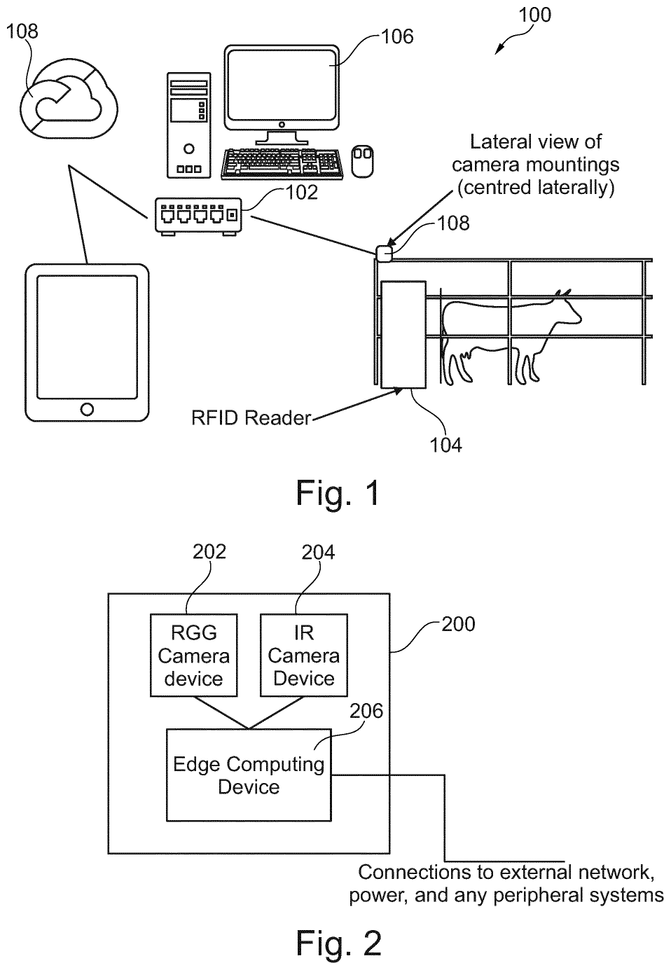

An overview of a complete system architecture 100 is shown in FIG. 1 for calculating an estimate of a body condition score (BCS) for a bovine animal. In any embodiment, the body condition score (BCS) is a type of a biometric parameter of an animal. Other biometric parameters applicable to the method and system described herein are animal heat, animal respiration, and animal milk production yield.

A compute node 102 is located on the farm and assumed to be positioned at a drafting gate. The node 102 includes the primary sensors and is connected to an existing RFID reader 104. The node 102 may include an RFID sensor for detecting an identification tag attached to an animal. Other tags and sensors may be employed such as barcodes and barcode readers. The node 102 is powered via an POE+ connector to a control route router. This route also provides access to a control PC and the internet. The control PC 104 is used for monitoring the camera box and also downloading occasional data dumps on an external hard drive during data collection periods. The cloud service 108 provides a central service for logging professionally labelled BCS scores during a training process, and also provides a service for logging and accessing BCS scores calculated during the runtime process.

The system further includes a camera system 110 communicatively coupled to the control node 102. The camera system 110 and the control node 102 form the hardware of the system which is further illustrated with reference to FIG. 2.

FIG. 2 is a block diagram of the system hardware 200 employed in the system and method of the invention. The system 200 includes a visual spectrum camera 202 configured to collect visual spectrum data of the animal in an area of interest, and an infra-red camera 204 configured to collect near infra-red spectrum data of the animal related to soft tissue distribution around the area of interest. In any embodiment, the visible spectrum camera system 202 comprises a single RGB camera configured to capture images of the area of interest. The area of interest may be the rear of the animal surrounding the animal's pin bones. In an embodiment, the data collected by the visible spectrum camera system 202 and the infra-red camera 204 include video recordings.

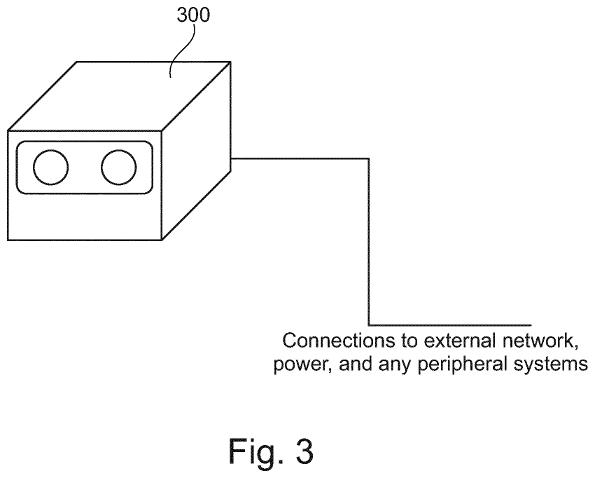

In an embodiment, the infra-red camera 204 and the visual spectrum camera 202 may be contained in a single camera unit 300 (also known as sensing box) as shown in FIG. 3. A transparent cover may be fixed on the outer casing of the unit 300 to provide protection for the camera lenses. The system hardware is focused on the elements required to build the sensing box. Other elements of hardware such as the control PC or a tablet or phone for using the cloud service are commodity elements, and there are no specific requirements here beyond modern operating systems. In an embodiment, the infra-red camera and the visual spectrum camera in the single camera unit 300 may be separated by less than 10 cm, and preferably by 5-6 cm.

In an embodiment, a pair of such units 300 may be positioned in separate locations in a fixed position above area of interest. In each pair of first and second such units, the first unit is positioned at a fixed angle with respect to the second, and the angle between the camera units is between 20 and 70 degrees. Preferably, the angle between the pair of camera units is around 45 degrees.

Referring back to FIG. 2, the system 200 further includes an edge computing device 206 that includes a processor that combines the image data from the visual spectrum camera 202 and the infra-red camera 204. The processor then runs one or more neural networks trained using a first training dataset comprising combined imaging data for each of a plurality of animals and corresponding biometric parameters for the plurality of animals, in which the combined imaging data for each animal comprises the visual spectrum data and the near infra-red spectrum data for the animal. The processor is further configured to receive the combined imaging data for the animal; and apply the one or more neural networks to the combined imaging data for the animal to calculate a biometric parameter estimate for the animal. In an example, the combined imaging data is fed to the neural network to estimate labels for BCS values and BCS confidence. In an embodiment, the neural network comprises a machine learning algorithm, preferably a deep learning algorithm.

In an example, the neural network is trained by providing a large number of inputs (e.g. greater than 50, 100, 150, 200, 300, 400 or 500) which comprise combined imaging data and an associated label (corresponding BCS's in the case of the first neural network). The label comprises a BCS score, and the BCS score ranges from 1 to 5. In an embodiment, the data model has been trained on this data, new data of the same type will be automatically classified in this target range by the neural network.

In an embodiment, the processor runs a confidence estimate model to calculate the accuracy of the calculated biometric parameter sample estimate for the animal. The confidence estimate mode includes one or more neural networks which are trained using a confidence training dataset comprising combined imaging data for each of a plurality of animals in a good imaging position and combined imaging data for each of a plurality of animals in a bad imaging position, in which the processor is configured to apply the confidence estimate model to the combined imaging data for the animal to calculate the accuracy of the calculated biometric parameter sample estimate for the animal.

In an embodiment, the processor is further configured to perform longitudinal analysis for one or more animals over a time period to estimate most likely biometric parameter estimates for the or each animal over a specified sampling period. Longitudinal analysis combines multiple features, including biometric parameter estimates and biometric parameter confidence measures, to estimate an aggregate high-quality biometric parameter estimate over any given sampling time, for example 1, 2, 3, 4, 5, 6, 7 or 8 weeks. The method makes use of weighting function and a rolling window of measurements of each animal where due to data loss or occlusion the observation for an animal on a given day may or may not be made available. The parameterisation of such a weighting function may be hand set or derived via an automated learning technique.

In an embodiment, the edge computing device 206 works in real time or near real time to provide estimates of BCS scores and optional BCS confidence estimates. In an embodiment, the lag with respect to real time is around 2-3 seconds. In any embodiment, the BCS estimate and the BCS confidence are captured twice per day for a given animal.

In an embodiment, the edge computing device 206 runs a master algorithm to assess the BCS confidence and BCS score for a given animal over a specified rolling window. The master algorithm estimates the most likely BCS score for a given animal by accounting for values and confidence levels for an animal over the specified rolling window. In an example, the rolling window length is 7 days. The automated estimates and the most likely BCS score may be communicated to a cloud platform for long term storage and review.

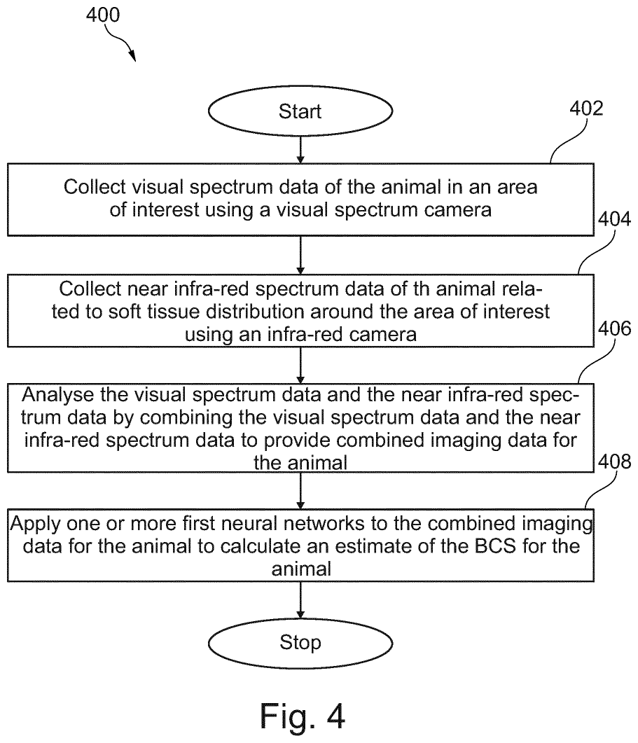

FIG. 4 is a flowchart illustrating a method for calculating a biometric parameter estimate for an animal. It is to be apparent to one of ordinary skill in the art, that the method has been performed by the system elements illustrated in FIGS. 1-3. In an embodiment, the biometric parameter is an estimate of a body condition score (BCS) for an animal. Other biometric parameters applicable to the method and system described herein are animal heat, respiration, and milk production yield.

At step 402, the visual spectrum data of the animal in an area of interest is collected using a visual spectrum camera.

At step 404, near infra-red spectrum data of the animal related to soft tissue distribution around the area of interest is collected using an infra-red camera.

At step 406, the visual spectrum data and the near infra-red spectrum data are analysed by combining the visual spectrum data and the near infra-red spectrum data to provide combined imaging data for the animal.

At step 408, one or more first neural networks are applied to the combined imaging data for the animal to calculate a biometric parameter sample estimate for the animal, in which the one or more first neural networks are created by (a) obtaining a first training dataset comprising combined imaging data for each of a plurality of animals and corresponding biometric parameters for the plurality of animals and (b) training one or re neural networks using the training database.

### Software Overview

There were a number of different clusters of software developed to assist in different aspects of the invention. These are summarized below before being detailed in the next section.
Data Collection Platform Software. The data collection platform software 20 consisted of a number of scripts and modules that ran on the hardware platform in order to record data from the different sensors. This software was designed to run periodically or on demand within the red box. Data collected was stored directly on the red box.
Data Collection Cloud Software. While the data collection platform software collected raw sensor data, it was not responsible for collecting information on gold standard BCS scores. Instead this responsibility was met by the Data Collection Cloud Software which ran on a Google Cloud instance and was powered by a Django based application. This software could be used via any modern web interface including a desktop browser or mobile phone.
Data Processing & Model Development Software. In order to build estimation software, it is necessary to review collected data, transform it in different ways, and prepare the data for training a model instance. These steps are usually complex and time consuming to execute. The software to support these steps was again written in the Python language and was in some cases executed on compute clusters due to the high volume of data involved and time required to train models.
Runtime Estimation Software. Based on trained models, the runtime estimation software runs directly on the red box and provides BCS estimates for an animal when it passes by the camera. This software again is written in Python and takes advantage of the compute power of the Jetson devices to run on the hardware.
Runtime Cloud Software. The cloud service also provides a destination for estimated BCS scores to be saved on a central storage system. This interface allows farmers or other stakeholders to view BCS estimates for their animals.

### EQUIVALENTS

The foregoing description details presently preferred embodiments of the present invention. Numerous modifications and variations in practice thereof are expected to occur to those skilled in the art upon consideration of these descriptions. Those modifications and variations are intended to be encompassed within the claims appended hereto.

1. A system for calculating an estimate of a body condition score (BCS) for a bovine animal, the system comprising:
a visual spectrum camera configured to collect visual spectrum data of the animal in an area of interest;
an infra-red camera configured to collect near infra-red spectrum data of the animal related to soft tissue distribution around the area of interest;
one or more neural networks trained using a first training dataset comprising combined imaging data for each of a plurality of animals and corresponding BCS's for the plurality of animals, in which combined imaging data for each animal comprises the visual spectrum data and the near infra-red spectrum data for the animal; and
a processor configured to:
receive the combined imaging data for the animal; and
apply the one or more neural networks to the combined imaging data for the animal to calculate an estimate of a BCS for the animal.

2. A system according to claim 1, in which the system comprises a confidence estimate model to calculate the accuracy of the calculated BCS for the animal, in which the confidence estimate model is trained using a confidence training dataset comprising combined imaging data for each of a plurality of animals in a good imaging position and combined imaging data for each of a plurality of animals in a bad imaging position, in which the processor is configured to apply the confidence estimate model to the combined imaging data for the animal to calculate the accuracy of the calculated BCS for the animal.

3. A system according to claim 1 or 2, in which the system comprises an RFID sensor for detecting an RFID identification tag attached to the animal.

4. A system according to claim 1 and 2, in which the system is configured to perform longitudinal analysis for one or more animals over a time period to estimate most likely biometric parameter estimates for the or each animal over the time period, in which the processor is configured to combines BCS estimates and accuracy calculation to estimate an aggregate BCS estimate over the time period.

5. A system according to claim 4, in which the processor is configured to employ a weighting function and a rolling window of measurements of the animal.

6. A system according to any preceding claim, in which the visible spectrum camera system is a video recorder.

7. A system according to any preceding claim, in which the visible spectrum camera system comprises a single RGB camera configured to capture images of the area of interest.

8. A system according to any preceding claim, in which the visual spectrum camera and the infra-red camera are positioned to image the rear of the animal surrounding the animal's pin bones.

9. A system according to any preceding claim, in which the infra-red camera and the visual spectrum camera are contained in a combined imaging module.

10. A system according to claim 9 comprising a plurality of combined imaging modules positioned in separate locations in a fixed position above the area of interest of the animal.

11. A system according to claim 10, in which a first combined imaging module is positioned at a fixed angle of 20 to 70 degrees with respect to a second combined imaging module.

12. A system according to claim 10, in which the first combined imaging module is positioned at a fixed angle of 40 to 50 degrees with respect to the second combined imaging module.

13. A system according to claim 9, in which the infra-red camera and the visual spectrum camera in the combined imaging module are separated by less than 10 cm.

14. A system according to claim 13, in which the infra-red camera and the visual spectrum camera in the combined imaging module are separated by 5-6 cm.

15. A system according to any preceding claim, in which the processor is processor is configured to combine the visual spectrum data and the infra-red data implicitly by a script.

16. A system according to any preceding claim, in which the first training dataset comprises combined imaging data for each of a plurality of animals and corresponding biometric parameters for at least 500 animals.

17. A system according to claim 1, in which the system is configured to provide estimates of BCS scores and optional BCS confidence estimates in real time or near real time.

18. A system according to claim 1 and 2, comprising a master algorithm to assess the BCS confidence and BCS score for a given animal over a specified rolling window.

19. A system according to claim 16, in which the master algorithm is configured to estimate the most likely BCS score for a given animal by accounting for values and confidence levels for an animal over the specified rolling window.

20. A system according to claim 18 or 19, in which the rolling window length is 7 days.

21. A system according to any preceding claim, configured for wireless communication of the BCS estimate, accuracy calculation, or most likely BCS score to a cloud platform for long term storage.

22. A method for calculating an estimate of a body condition score (BCS) for a bovine animal, the method comprising the steps of:
collecting visual spectrum data of the animal in an area of interest using a visual spectrum camera;
collecting near infra-red spectrum data of the animal related to soft tissue distribution around the area of interest using an infra-red camera;
analysing the visual spectrum data and the near infra-red spectrum data by combining the visual spectrum data and the near infra-red spectrum data to provide combined imaging data for the animal; and
applying one or more first neural networks to the combined imaging data for the animal to calculate an estimate of the BCS for the animal, in which the one or more first neural networks are created by (a) obtaining a first training dataset comprising combined imaging data for each of a plurality of animals and corresponding BCS's for the plurality of animals and (b) training one or more neural networks using the training dataset.

23. A method according to claim 22, in which the method comprises applying a confidence estimate model to the calculated BCS estimate for the animal so as to calculate the accuracy of the calculated BCS estimate for the animal, in which the confidence estimate model is created by (a) obtaining a confidence training dataset comprising combined imaging data for each of a plurality of animals in a good imaging position and combined imaging data for each of a plurality of animals in a bad imaging position, and (b) generating the confidence estimate model using the confidence training dataset.

24. A method according to claim 23, in which the confidence estimate model comprises one or more neural networks, in which the neural network optionally comprises a machine learning algorithm.

25. A method according to claim 22 and 23, in which the method comprises
performing longitudinal analysis for one or more animals over a time period to estimate most likely biometric parameter estimates for the or each animal over the time period, including combining BCS estimates and accuracy calculations to estimate an aggregate BCS estimate over the time period.

26. A method according to claim 25, in which the longitudinal analysis comprises employing a weighting function and a rolling window of measurements of the animal.
